(19) United States
(12) Patent Application Publication
(10) Pub. No.: US 2006/0130450 A1
(43) Pub. Date: Jun. 22, 2006

(54) Air purifier

(76) Inventor: Shao-Shih Huang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/014,986

(22) Filed: Dec. 20, 2004

(51) Int. Cl. B01D 46/00

(52) U.S. Cl. 55/471

(57) ABSTRACT

An air purifier includes a filter, a compressor, an oxygen maker, an electromagnetic valve and a fan, and all of which are mounted in a case. The case has an inlet vent, an outlet vent, and a filtering member next to the outlet vent. The compressor comprises an air inlet and an air outlet. The air inlet of the compressor is connected to the filter, while the air outlet is connected to the oxygen maker. The oxygen maker comprises an air inlet connected to the air outlet of the compressor, an oxygen outlet connected to the electromagnetic valve, and a nitrogen outlet. The electromagnetic valve is connected to the fan. The fan is secured next to the outlet vent of the fan.

### FIELD OF THE INVENTION

This invention relates to an air purifier, and more particularly to a purifier to produce oxygen and filter odors and germs in the air.

### BACKGROUND OF THE INVENTION

Conventional air purifiers are generally in two categories. One is indoor type while the other is window type. The indoor type is placed at a comer in the room, which not only provides purified air but also exhausts waste gas. The window type expels exhaust to the outdoor, but it can't produce enough purified air for indoor use due to its structure.

### SUMMARY OF THE INVENTION

It is the primary objective of the present invention to provide an air purifier, which is able to produce purified air in a continuous method.

It is another objective of the present invention to provide the air purifier, which eliminates odors thoroughly.

### BRIEF DESCRIPTION OF THE DRAWINGS

FIG. 1 is an exploded view of the present invention;

FIG. 2 is a perspective view of the present invention;

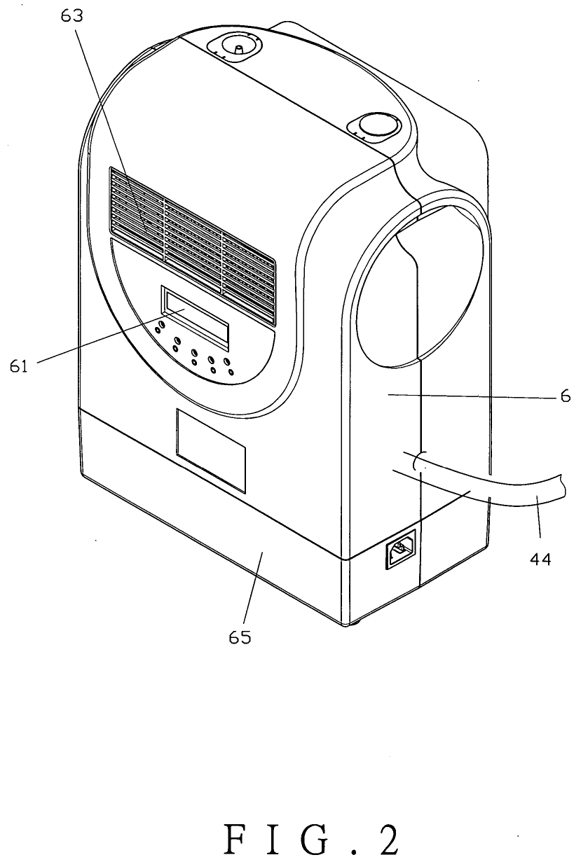

FIG. 3 is a block diagram of the present invention

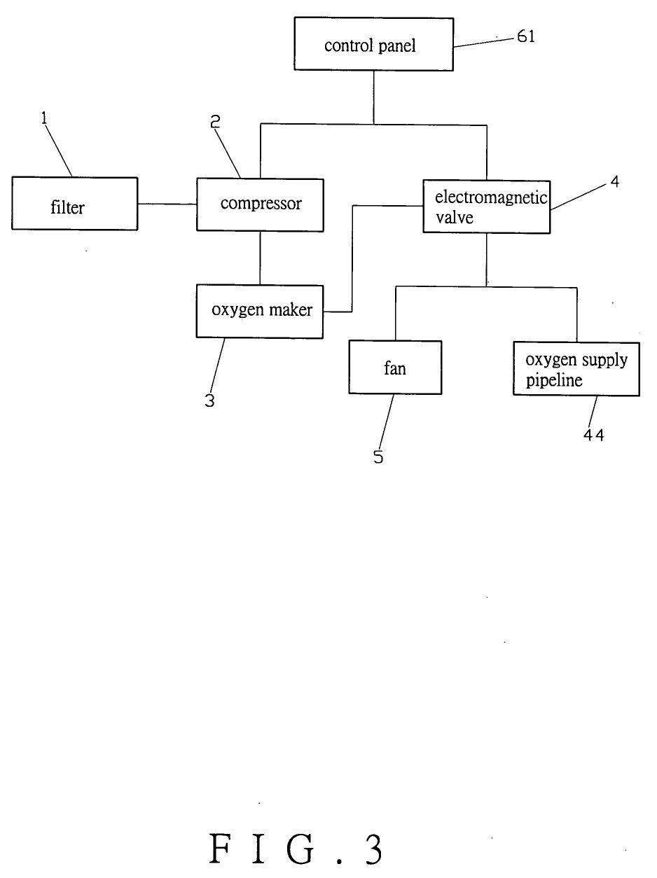

FIG. 4 is a perspective view of the present invention in operation.

### DETAILED DESCRIPTION OF THE PREFERRED EMBODIMENT

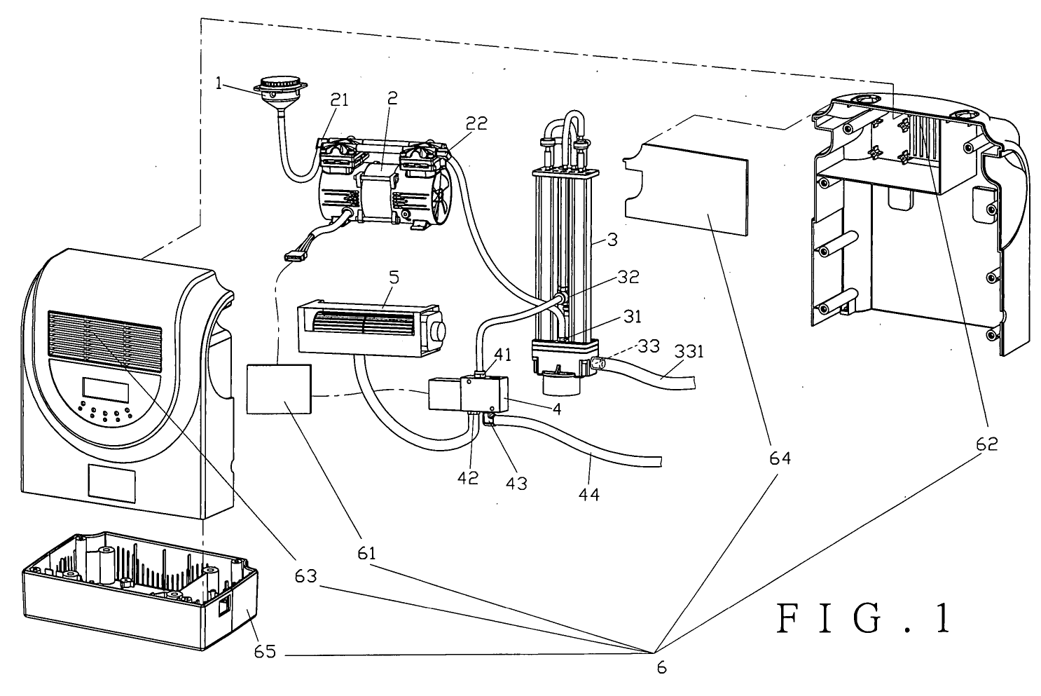

The present invention, as shown in FIGS. 1˜3, comprises a filter 1, a compressor 2, an oxygen maker 3, an electromagnetic valve 4, and a fan 5, and all of which are securely mounted in a case 6.

The case 6 comprises a control panel 61, an inlet vent 62 on the rear plate of the case 6, an outlet vent 63 on the front plate of the case 6, a filtering member 64 next to the inlet vent 62, and a base 65 at the bottom of the case 6. The filtering member 64 is to filter any germs in the air, and it can be an anion filter, high particulate arrestance (HEPA) or Photocatalyst material. The control panel 61 is to activate the compressor 2 and switch the electromagnetic valve 4.

The compressor 2 comprises an air inlet 21 and an air outlet 22. The air inlet 21 is connected to the filter 1 which corresponds to the inlet vent 62 and the filtering member 64 of the case 6, while the air outlet 22 is connected to the oxygen maker 3.

The oxygen maker 3 comprises an air inlet 31, an oxygen outlet 32 and a nitrogen outlet 33. The air inlet 31 is connected to the air outlet 22 of the compressor 2. The oxygen outlet 32 is connected to the electromagnetic valve 4. The nitrogen outlet 33 is connected to a pipeline 331.

The electromagnetic valve 4 comprises an inlet valve 41, and two outlet valves 42 and 43. The inlet valve 41 is connected to the oxygen outlet 32 of the oxygen maker. The outlet valve 42 is connected to the fan 5, while the other outlet valve 43 is connected to an oxygen supply pipeline 44.

The fan 5 is secured in the case 1 in relation to the outlet vent 63 of the case 1 to blow oxygen out of the case 1.

To operate the present invention, the air purifier is mounted on a window. The compressor 2 is activated to suck air from outside into the case 6 through the inlet vent 62 and the filtering member 64. The air goes through the filter 1 for a secondary filtering before going into the oxygen maker 3. Oxygen will be extracted from the filtered air in the oxygen maker 3 and delivered from the oxygen outlet 32, through the outlet valve 42 of the electromagnetic valve 4, and blown into the room by the fan 5. While the unnecessary nitrogen and exhaust from the air will be expelled through the nitrogen outlet 33 and the pipeline 331 to outdoor.

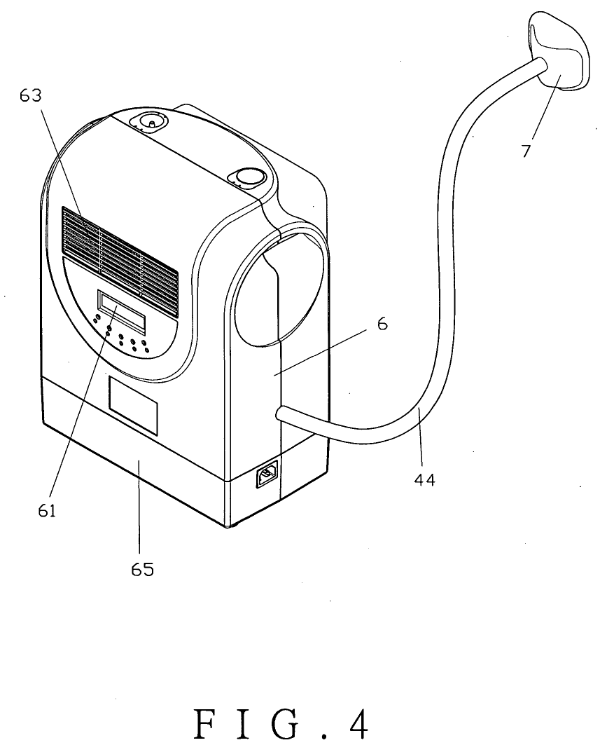

In case of extra oxygen is needed, the outlet valve 43 of the electromagnetic valve 4 is able to supply by connecting the outlet valve 43 to an oxygen device 7, as shown in FIG. 4. In this case, an oxygen mask is used as the oxygen device 7. To operate this device, the control panel 6 is adjusted to switch the outlet valve on, thus oxygen from the oxygen maker 3 to the electromagnetic valve 4 can be supplied to the oxygen mask 7 through the oxygen supply pipeline 44.

I claim:

1. An air purifier comprising a filter, a compressor, an oxygen maker, an electromagnetic valve and a fan mounted within a case;
said case comprising an inlet vent, an outlet vent, and a filtering member next to said inlet vent;
said compressor comprising an air inlet and an air outlet, said air inlet being connected to said filter in relation to said inlet vent and said filtering member of said case;
said oxygen maker comprising an air inlet, an oxygen outlet and a nitrogen outlet, said air inlet of said oxygen maker being connected to said air outlet of said compressor;
said electromagnetic valve comprising an inlet valve and an outlet valve, said inlet valve being connected to said oxygen outlet of said oxygen maker, said outlet valve being connected to said fan which is secured next to said outlet vent of said case.

2. The air purifier, as recited in claim 1, wherein said electromagnetic valve comprises another outlet valve.
